(19) United States
(12) Patent Application Publication
(10) Pub. No.: US 2006/0130378 A1
(43) Pub. Date: Jun. 22, 2006

(54) Floor advertising means

(76) Inventor: Igor Efimovich Rybalov, Moscow (RU)

Correspondence Address: Maria M. Eliseeva;Houston Eliseeva LLP, Ste. 4, 4 Militia Drive, Lexington, MA, 02421, US

(21) Appl. No.: 11/150,479

(22) Filed: Jun. 10, 2005

(30) Foreign Application Priority Data
Dec. 10, 2002 (RU) 2002000133058

(51) Int. Cl. G09F 13/18

(52) U.S. Cl. 40/546

(57) ABSTRACT

The inventive flop advertising means exhibits an increased operational efficiency and comprises a floor module which is provided with a light-diffusion plate arranged between a light source and a top translucent panel. An advertising and information image is disposed on the surface of said light diffusion plate which is oriented towards the top panel.

### CROSS REFERENCE TO RELATED APPLICATIONS

This application is a continuation application of International patent application PCT/RU03/000546 filed on Dec. 10, 2003, which International patent application, in turn, claims priority to an earlier filed Russian patent application RU 2002133058, filed on Dec. 10, 2002. which applications are incorporated herein by reference in their entirety.

### FIELD OF THE INVENTION

The invention pertains to the advertising business and, more specifically, to the illuminated advertising floorboard. The invention can be used in a large setting amongst a large group of people, such as airport waiting rooms, train stations, subway and metro stations, as well as large supermarkets, dance floors, concert hall foyers, and display studios, among others.

### BACKGROUND OF THE INVENTION

There is the known illuminated informational advertising block according to utility model RU patent #24586, MPK 7 G09F 13/00, 10.08.2002 containing the body in the shape of a vertically oriented, flattened parallelepiped. The walls of the body are made from transparent material; parallel to the surfaces made of transparent materials there are sheets of light diffusing glass, fixated with clamps. Inside the body there are no less than two lamps, placed symmetrically between the sheets of light diffusing glass. The advertising or information image is secured on the light diffusing glass, on the sides, turned to the transparent surfaces. To the device is attached a foundation, secured in its turn, with anchor bolts to the base cushion. The advertising image stands out above the ground level and interferes with pedestrian traffic, therefore it is limited in its usage. Specifically, it cannot be used in airport waiting rooms, train stations, subway and metro stations, as well as large supermarkets, dance floors, and concert hall foyers, among others.

There is known a lifted low profile panel floor with a metallic supporting construction, according to the RU patent #2116412, MPK 7 E04F 15/024, 27.07.1998. The lifted floor for the placement above the existing floor contains the floor panel, the central protruding section supporting the floor panel, which crosses numerous shoulders of floor panels. The given floor (false floor) creates a free space under the floor for laying pipelines, cables and service lines. The top panels of the floor are made with an increased mechanical stability from an opaque material, such as zinc coated steel. The described raised floor cannot be used for the placement of lighted advertising.

There is a known glass floor produced by the firm Sun Master, found in the firm brochure on the Internet at http://www.sunmaster.ru. Glass floors are mounted on a base construction and can consist of one panel (window) or any amount of panels, making up part of the floor or the entire floor. The floors have a strong transparent panel on top, made, for example, from tempered glass. In the niche disposed occurring between the floor foundation and the transparent top panel, are placed lamps of various colors. The described glass floor is not used for the placement of advertisement.

### SUMMARY OF THE INVENTION

The present invention solves the problem of increasing the information content about the advertised object or service, increasing attention among a large number of potential customers to various product manufacturers and service organizations. The invention also solves the problem of increasing the effectiveness of advertising, since it is offered to the consumers waiting for transport at the train stations, airports, subway platforms, etc. or relaxing in the dance halls, exhibitions, etc.

The described problem is solved in accordance with the first embodiment of the invention, wherein the advertising floorboard incorporates at least one floor paneled module, containing a niche housing within it a light source, and a top transparent panel, mounted on supporting elements; the floor panel module is equipped with a light diffusing plate disposed between the light source and the top transparent panel. On the light diffusing panel on the side facing towards the top transparent panel, is placed the advertising image. At the same time the floor panels can have more than one light source, which are placed in the bottom part of the niche oriented towards the transparent panel. Light sources can also be placed on the side portions of the niche, in which case the surface of the niche should be made from a reflective material, such as a mirror.

In the second embodiment of the invention, the advertising floorboard containing at least one paneled floor module with a niche having a light source placed inside of it, and a top transparent panel, mounted on supporting elements, the floor paneled module a transparent plate disposed under the transparent panel, and the niche housing the lighting source is disposed at the side of the module, adjacent to at least one side face of the light-conducting panel and has a top surface of an opaque material, wherein the advertising and information image are disposed on one of the sides of the transparent plate. The floor paneled module can have more than one light source, and the niche housing the light sources can be implemented along the perimeter of the module. The lighting sources are placed along the niche at about equal intervals. For the described embodiments, it is typical that the advertising and information image is implemented as a light diffusing reflecting image disposed on one of the polished surfaces of the transparent plate.

The transparent (light conducting) plate for the described embodiment of the invention can be implemented as a multi-layered material, and on the top of each layer there can be made a diffused-reflective advertising and information image, similar or different from the advertising and information images on the other layers. The advertising image can be made on film carriers, disposed on one of the sides of the transparent plate.

Just as the first embodiment, so can the second be comprised of one or several floor paneled modules. The module can have any form, although it is preferable to make it in the form of a parallelepiped, and to make the transparent panel detachable. When the advertising floor board is formed from the kit of modules, each full panel module can have individual advertising and information images, or one whole advertising and information image can be created from a combination of full panel modules.

The following examples can pertain to both embodiments of the advertising floorboard.

To provide for the necessary strength of the parts, the transparent panel should be made of tempered (armored) glass.

To eliminate slipping during movement over the floor board, it is expedient that the transparent panel be made with a roughness or relief on its external surface.

The transparent panel can be made in matte, i.e. with a transmittance less than one.

The advertising or information image can be made with paint or on a film carrier. It can be made in the form of a hologram, in which case it is necessary to use a light source with a coherent wavelength, such as, for example, a laser.

The advertising and information image can be made on a paper carrier or any other carrier.

For the convenience of changing the carrier of the advertising image to the new one, it should be made interchangeable.

Light sources can be linear, such as neon lights, as well as point sources, such as light diodes and/or laser diodes with similar or different wave lengths.

Light sources can be connected to an electrical outlet allowing one to control the time regimes of their switching the combinations of connecting the light sources, and the adjustment of their brightness.

### BRIEF DESCRIPTION OF THE DRAWINGS FIGURES

FIG. 1 and FIG. 2 are schematic illustrations of the information presentation apparatus in accordance with the first embodiment;

FIG. 3 is a schematic illustration of the information presentation apparatus in accordance with the second embodiment.

### DETAILED DESCRIPTION OF THE INVENTION

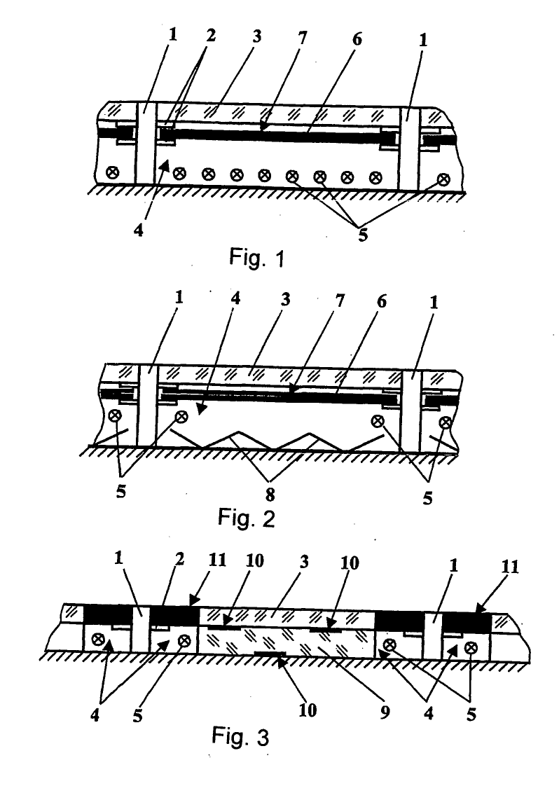

The essence of the invention is explained in the drawings, which do not include every particular variation of the advertising floorboard. In FIG. 1 and FIG. 2 possible implementations of the first embodiment are schematically presented, FIG. 3 presents the second embodiment of the invention.

According to the first embodiment, the advertising floorboard comprises attached to a base supporting elements 1 with supporting planes 2 on which top transparent panels 3 are mounted forming at least one floor paneled module. Transparent panels 3 are preferably made of tempered (armored) glass. Between transparent panel 3 and the base, there is a niche 4 housing at least one source of illumination 5 and a system of cables from a source of voltage and a control system of light source 5 (not shown in the drawings). The light sources 5 are disposed in the bottom part of niche 4 and face towards transparent panel 3. In each module, between light source 5 and top transparent panel 3, a light diffusing plane 6 is disposed on the supporting planes 2, an advertising or information image 7 is disposed on such surface of transparent plate 6 that faces transparent panel 3.

Light sources 5 can also be disposed in the side portions of the niche 4, in which case the bottom surface of the niche is made as a reflective surface 8, a mirror.

According the second embodiment, the advertising floorboard comprises attached to the base supporting elements 1 with supporting planes 2, on which top transparent panels 3 are mounted, forming at least one floor paneled module. Between the base and transparent panel 3 transparent plate 9 is disposed. On at least one of the polished sides of the transparent plate 9 is placed a diffused-reflective advertising and informational image 10. Transparent plate 9 for the described embodiment can be implemented as a multi-layered material, and on the surface of every layer there can be a diffused-reflective advertising image 10 either similar or different from the images on the other layers. Advertising image 10 can also be disposed on a film carrier located on one of the sides of the transparent plate 9. In the described embodiment niche 4 housing light source 5 and the system of cables is disposed in the side portion of the module adjacent to one of the edges (side portions) of transparent plate 9, and contains in the top part an opaque surface 11. If there is more than one lighting source 5, the niche 4 for the lighting sources 5 is implemented along the perimeter of the module. The lighting sources are placed along the niche 4 at about equal intervals.

For both embodiments of the invention, it is typical that the advertising and information image 7 or 10 is painted on a paper carrier, or a film carrier, or any other carrier. The advertising and information image can be made in the form of a hologram (photo film) as well, in which case it is necessary to use a light source 5 with a coherent wavelength, a laser. Light sources can be linear, such as neon lights, as well as point sources, such as light diodes and/or laser diodes with similar or different wave lengths. Light sources can be connected to an electrical outlet allowing one to control the time regimes of their switching the combinations of connecting the light sources, and the adjustment their brightness.

In addition to the aforementioned constructional changes, other constructional changes can be made without going outside of the scope of the invention, as should be obvious to a person skilled in the art.

When the advertising floorboard functions according to the first embodiment, a voltage of an appropriate magnitude is applied to light source 5 continuously or following a given program. The light from light source 5, having gone through light diffusing plane 6, is equally distributed on its surface and illuminates the advertising image disposed on carrier 7, which image is projected on transparent panel 3.

When the advertising floorboard functions according to the second embodiment, the light from the lighting sources goes through the transparent plate 9, giving it in polished areas an even hue corresponding to the color of the lighting. Advertising image 10 disposed on transparent plate 9, for example, by engraving, forms areas of diffused reflection, which are seen as glowing images on an evenly lit background. In this way, informational signs 10 are lit on the surface of transparent panel 3.

The proposed modular advertising floorboard device (apparatus) with controllable creative illumination of the advertisement signs by various lighting sources, exhibits enhanced informational and visual content and dynamics, allowing to light elements of the advertising signs in different colors and intensities and in various time intervals.

The main advantage of the present advertising floorboard device is its non-traditional means of presenting advertising information in large areas, frequented by large numbers of people, which, in the end, increases the effectiveness of the advertising. In this way, the invention draws the attention of a wide array of potential buyers and users of the services to the manufacturers of various products and service organizations, as well as allows to present images with informational content.

What is claimed is:

1. An information presentation apparatus comprising:
a module having a transparent panel and a niche housing a light source; and
a light diffusing plate spaced apart from the transparent panel and disposed between the transparent panel and the light source serving to illuminate the light diffusing plate, the light diffusing plate comprising the information disposed on its surface that faces the transparent plate.

2. The information presentation apparatus of claim 1, comprising more than one light source disposed apart from the light diffusing plate and oriented toward the transparent panel.

3. The information presentation apparatus of claim 1, comprising more than one light source disposed in side portions of the niche apart from the light diffusing plate and between a light reflecting surface and the light diffusing plate.

4. An information presentation apparatus comprising:
a module having a transparent panel, a transparent plate adjacent to the transparent panel, and a niche;
the niche having an opaque surface generally oriented in parallel with the transparent panel, the niche being disposed in a side portion of the module adjacent to a side face of the transparent plate and housing a light source; and
the transparent plate comprising the information disposed on at least one surface of the transparent plate.

5. The information presentation apparatus of claim 1, wherein the module comprises a plurality of light sources, the niche is disposed along a perimeter of the module and the plurality of light sources is disposed inside the niche at an equal interval from each other.

6. The information presentation apparatus of claim 4, wherein the information is implemented as a light diffusing image disposed on at least one surface of the transparent plate.

7. The information presentation apparatus of claim 4, wherein the transparent plate is made of a multilayer material and wherein the surfaces of each layer comprise one or more similar or different light diffusing images.

8. The information presentation apparatus of claim 4, wherein the information is presented on a film disposed on at least one surface of the transparent plate.

9. The information presentation apparatus of claim 4 comprised of two or more modules.

10. The information presentation apparatus of claim 1 comprised of two or more modules.

11. The information presentation apparatus of claim 4, wherein the modules is shaped as a parallelepiped.

12. The information presentation apparatus of claim 1, wherein the modules is shaped as a parallelepiped.

13. The information presentation apparatus of claim 4, wherein the transparent panel is made of tempered glass.

14. The information presentation apparatus of claim 1, wherein the transparent panel is made of tempered glass.

15. The information presentation apparatus of claim 4, wherein an external surface of the transparent panel has roughness or a relief.

16. The information presentation apparatus of claim 1, wherein an external surface of the transparent panel has roughness or a relief.

17. The information presentation apparatus of claim 4, wherein a transmittance of the transparent panel is less than 1.

18. The information presentation apparatus of claim 1, wherein a transmittance of the transparent panel is less than 1.

19. The information presentation apparatus of claim 4, wherein the transparent panel is detachable.

20. The information presentation apparatus of claim 1, wherein the transparent panel is detachable.
